(19) United States
(12) Patent Application Publication
(10) Pub. No.: US 2019/0093985 A1
(43) Pub. Date: Mar. 28, 2019

(54) DETACHABLE MOTION-ACTIVATED RECORDING MEANS FOR FIREARMS

(71) Applicant: Adam Robinson, Richfield, UT (US)

(72) Inventor: Adam Robinson, Richfield, UT (US)

(21) Appl. No.: 15/719,440

(22) Filed: Sep. 28, 2017

(51) Int. Cl. F41C 27/00; H04N 7/18; H04N 5/225; H04N 5/91

(52) U.S. Cl. CPC F41C 27/00; H04N 7/188; H04N 5/91; H04N 5/2256; H04N 5/2253

(57) ABSTRACT

An apparatus and detachable motion-activated recoding system for a firearm, the system detachable to a trigger guard, the camera system comprising video recording means and/or one of a motion-sensor and a light-sensor. The apparatus and system are adapted to record whatever the firearm is being pointed at whenever the firearm is drawn from a holster.

### FIELD OF THE INVENTION

This invention relates to firearms, and more particularly relates to camera and recording devices for firearms and law enforcement.

### BACKGROUND

### Description of the Related Art

Along with the proliferation of smart phones and tablet computers equipped with digital cameras has come increased attention on police shootings, which have become more commonly recorded with these cameras. Many jurisdictions now require police officers to wear body cameras or other auxiliary recording apparati on the officer's person or within the officer's patrol vehicle. These cameras, however, are not always activated, practical or efficient. Police offers are sometimes unable to activate body cameras in times of duress and even when activated, these cameras are not always oriented properly to capture important events.

In present art, the mechanisms provided for activating a camera typically require depressing a button or activating some other type of manual switching apparatus which can hinder or delay an officer in a shooting or exigent event. It is desirable to equip a handgun or rifle with an auxiliary camera which is always oriented in the proper direction and which automatically activates in a crisis situation, but such a mechanism is unknown in the art. Accordingly, it is an object of the present invention is to provide a motion- or light-activated apparatus that automatically switches on an integrated media recording apparatus which is detachable to a firearm.

### SUMMARY

From the foregoing discussion, it should be apparent that a need exists for an efficient motion-activated recording means for firearms. Beneficially, such a device would overcome inefficiencies with the prior art by providing a detachable device with a self-contained power supply.

The present invention has been developed in response to the present state of the art, and in particular, in response to the problems and needs in the art that have not yet been fully solved by currently available apparti. Accordingly, the present invention has been developed to provide a camera system detachably affixable to a firearm, the camera system comprising: an L-shaped housing defining a hollow interior recess, an exterior surface of the L-shaped housing contoured to abut a forward surface of a trigger guard of the firearm; a digital camera having a lens, the lens of the digital camera oriented orthogonally to a barrel of the firearm such that the camera points toward anything positioned in front of the firearm; a power supply; computer-readable memory for storing digital media; a motion-sensor for activating the camera system; and attachment means for detachably affixing the L-shaped housing to the forward surface of the trigger guard.

The camera may further comprise a light-sensor. The attachment means may comprise a pair of claws for gripping the trigger guard in various embodiments.

The attachment means may comprise a bracket adapted to circumscribe a forward edge of the trigger guard in alternate embodiments. The attachment means may comprise a bracket adapted to circumscribe a lower edge of the trigger guard.

The camera may be positioned beneath the motion-sensor to give the camera increased field of vision. The camera may be positioned beneath the light-sensor to give the camera increased field of vision.

In various embodiments, the camera is positioned at a base of the trigger guard to give the camera increased field of vision. The camera system may further comprise a microphone.

A second camera system is provided which is detachably affixable to a firearm, the camera system comprising: a cylindrical housing defining a hollow interior recess and an exterior recess contoured to receive a corner of a trigger guard of the firearm; a digital camera having a lens, the lens of the digital camera oriented orthogonally to a barrel of the firearm such that the camera points toward anything positioned in front of the firearm; a motion-sensor for activating the camera system disposed above the digital camera; an internal power supply; computer-readable memory for storing digital media; and attachment means for detachably affixing the cylindrical housing to the corner of the trigger guard.

The camera system further comprises a light-sensor. The attachment means may comprise a pair of claws for gripping the trigger guard. The attachment means may comprise a bracket adapted to circumscribe a forward edge of the trigger guard.

The attachment means in other embodiments comprises a bracket adapted to circumscribe a lower edge of the trigger guard. In still further embodiments, the camera may be positioned at a base of the trigger guard to give the camera increased field of vision.

The camera system may further comprise a microphone.

A third camera system is provided which detachably affixed to a firearm, the camera system comprising: a cylindrical housing defining a hollow interior recess and an exterior recess contoured to receive a corner of a trigger guard of the firearm; a digital camera having a lens, the lens of the digital camera oriented orthogonally to a barrel of the firearm such that the camera points toward anything positioned in front of the firearm; a light-sensor for activating the camera system disposed above the digital camera; an internal power supply; computer-readable memory for storing digital media; and attachment means for detachably affixing the cylindrical housing to the corner of the trigger guard.

The camera system may further comprise a microphone and the attachment means may comprise a bracket adapted to circumscribe a forward edge of the trigger guard.

The attachment means may comprise a bracket adapted to circumscribe a lower edge of the trigger guard.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is an upper perspective view of a detachable motion-activated recording apparatus for firearms in accordance with the present invention;

FIG. 2 is an upper perspective view of a detachable motion-activated recording apparatus for firearms in accordance with the present invention;

FIG. 3A is a lower side perspective view of a holstered detachable motion- activated recording apparatus for firearms in accordance with the present invention;

FIG. 3B is a lower side perspective view of a detachable motion-activated recording apparatus for firearms in accordance with the present invention;

FIG. 4 is an upper perspective view of a detachable motion-activated recording apparatus for firearms in accordance with the present invention; and

FIG. 5 is an upper perspective view of a detachable motion-activated recording apparatus for firearms in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well- known structures, materials, or operations are not shown or described in detail to avoid obscuring aspects of the invention.

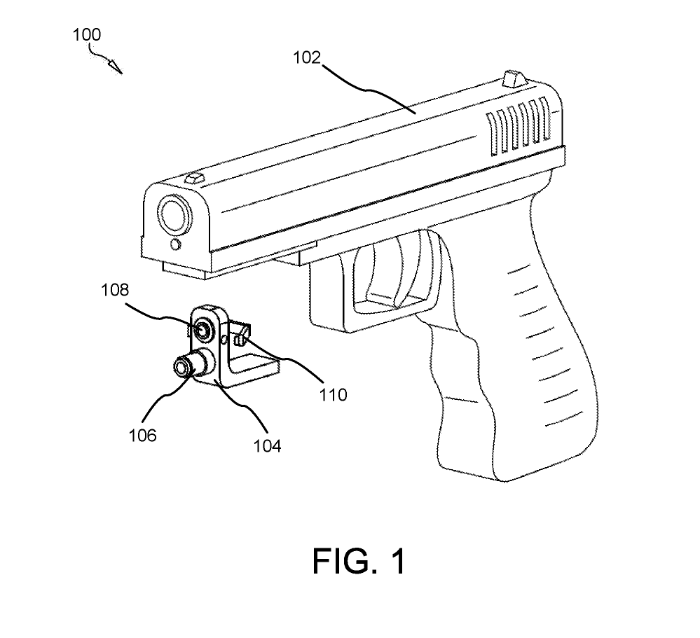

FIG. 1 is an upper perspective view of a detachable motion-activated recording apparatus 100 for firearms 102 in accordance with the present invention. The apparatus 100 comprises an L-shaped housing defining a hollow interior recess containing a power supply and various other components. In various embodiments, the housing 104 is affixed to a digital camera 106, a microphone, and one of a motion-sensor 108 and a light-sensor.

The housing 104 is L-shaped to contour an exterior forward surface of a trigger guard 112. In various embodiments, the housing 104 is configured or adapted to position on the forward lower corner of the trigger guard 112. In other embodiments, the housing 104 may be adapted to position on the forward edge of the trigger guard 112 and/or to a lower surface of the body of the firearm 102.

The motion sensor 108 may comprise any device for detecting motion of the firearm 102 and comprises the optical, microwave or acoustic means necessary for achieving such a function, including passive infrared (PIR), ultrasonic, and tomographic or a combination of any of the above as known to those of skill in the art.

The camera system 100 includes a digital camera 106 comprising a CMOS sensor and a lens assembly for recording video and/or still photographs. The video camera 106 may include a cylindrical body and is affixed to the housing 104. The video camera 106 is adapted to record media in computer-readable memory housed within the housing 104.

The microphone may be integrated into the camera 106 or the housing 104, and is well known to those of skill in the art. The camer

The apparatus 100, or system 100 comprise, attachment means 110 for detachably affixing the housing 104 to a forward edge of the trigger guard 112 of the firearm 102. This attachment means 110 may include a bracket which circumscribes a forward edge of the trigger guard 112. Alternatively, the attachment means 110 may comprise claws which are hingedly affixed to the housing 104 and which grip a forward edge of the trigger guard 112.

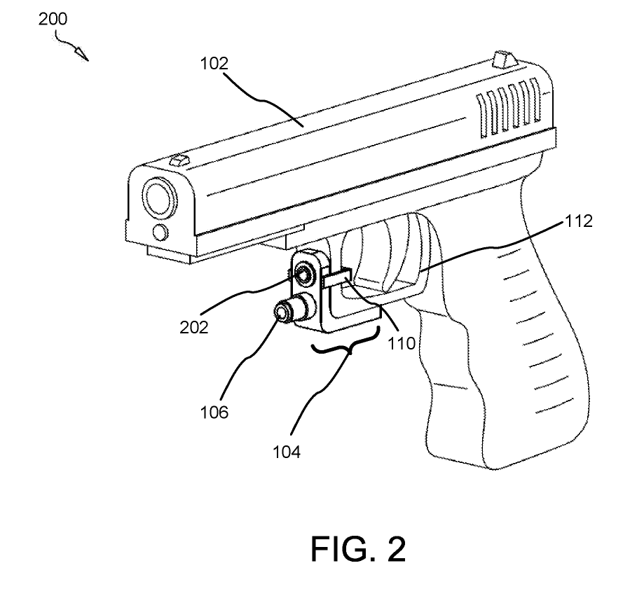

FIG. 2 is an upper perspective view of a detachable motion-activated recording apparatus 200 for firearms in accordance with the present invention.

In various embodiments, the apparatus 200 comprises a light-sensor 202 for detecting light and switching on the digital camera and recording functionality. The light sensor 202 may comprises any sensor of light or electromagnetic energy known to those of skill in the art, including a photoemission sensor, a photoelectric sensor, a photovoltaic sensor, a thermal sensor, a polarization sensor, a photochemical sensor and the like, or any combination of the above such that the apparatus 200 or system activates the digital camera 106 and recording functionality when the firearm 102 is drawn from a holster.

The attachment means 110 may comprise any attachment means known to those of skill in the art, including a bracket or strap, and may affix either to the forward or rearward edge of the trigger guard or alternatively to the body of the firearm itself including a rail underlying the barrel.

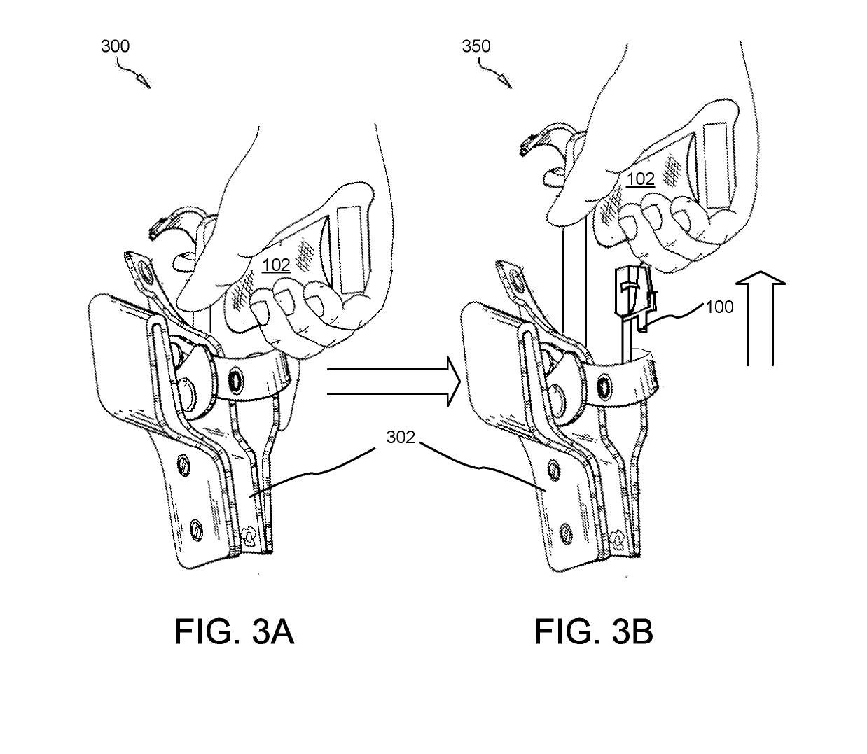

FIGS. 3A-3B illustrate lower side perspective views of a holstered firearm detachably affixed to a motion-activated recording apparatus 300 for firearms in accordance with the present invention.

As shown in FIG. 3A, the firearm 102 is holstered in a holster 302. The firearm 302 is drawn from the holster in FIG. 3B, thus exposing the apparatus 100 to light and/or infrared light and activating the digital camera 106, which records a predetermined length of video and/or audio in computer-readable memory. In various embodiments, the apparatus 100 may be configured to shut off recording when the computer readable memory is full, or to automatically overwrite recorded media when space is needed. In other embodiments, the apparatus 100 is configured to stop recording media after a predetermined period of time lapses without the sound of gunfire, or until manually switched off

In FIG. 3A, the firearm 102 and apparatus 100 are holstered while in FIG. 3B, the fire arm 102 and apparatus 100 are being drawn from the holster 302.

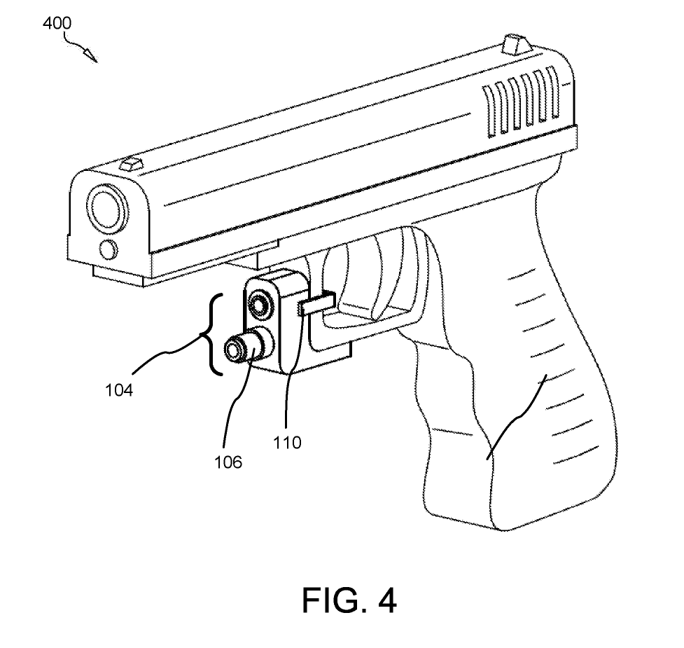

FIG. 4 is an upper perspective view of a detachable motion-activated recording apparatus 400 for firearms in accordance with the present invention.

In the shown embodiment, the housing 104 protrudes forward by a further distance than shown in apparatus 100. The dimension of the housing 104 varies from one embodiment to the other and must be sufficient only to house a power supply, computer- readable memory and/or a microphone and/or recording means. The housing 104 may be of any shape with any surfacing sufficient to support the recited components.

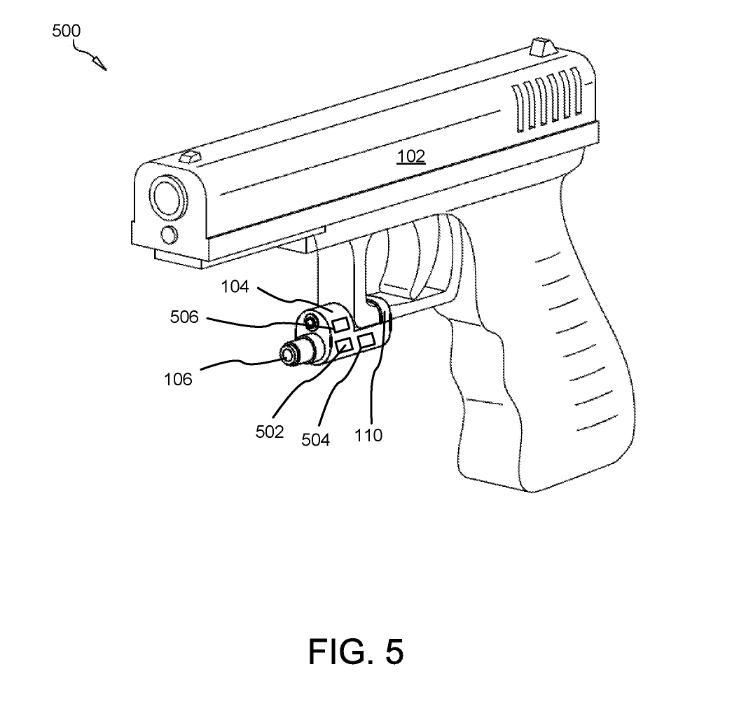

FIG. 5 is an upper perspective view of a detachable motion-activated recording apparatus 500 for firearms in accordance with the present invention. The apparatus 500 comprises a housing 104, a microphone 506, a digital camera 106, computer- readable memory 502, and a power supply 504.

In the shown embodiment, the housing 104 is roughly cylindrical, but recessed on its upper-rear surface to abut the forward-lower edge of the trigger guard 112 of the firearm 102. The attachment means 110 of the apparatus 500 circumscribes the lower edge of the trigger guard 112 rather than the forward edge. In this manner, the digital camera 106 is positioned further below the main body of the firearm 102 such that the barrel and slide do not obstruct the field of view of the digital camera 106.

By disposing the apparati 100-500 substantially on the forward edge of the trigger guard 112, the firearm 102 continues to rest in the holster 302 without modification of the holster 302. The apparatus 500 causing the firearm 102 to sit higher in the holster 302, but does not obviate the utility of the holster 302.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A camera system detachably affixable to a firearm, the camera system comprising:
a L-shaped housing defining a hollow interior recess, an exterior surface of the L-shaped housing contoured to abut a forward surface and lower surface of a trigger guard of the firearm;
a digital camera comprising a CMOS sensor having a lens, the lens of the digital camera oriented orthogonally to a barrel of the firearm such that the camera points toward anything positioned in front of the firearm;
a power supply;
computer-readable memory for storing digital media;
a motion-sensor for activating the camera system, the motion sensor positioned above the digital camera; and
a bracket adapted to circumscribe a forward surface of the trigger guard and detachably affix the L-shaped housing to the forward surface of the trigger guard;
wherein the camera system is positioned substantially on the forward edge of the trigger guard such that the firearm continues to rest in a holster 302 without modification of the holster.

2. The camera system of claim 1, further comprising a light-sensor.

3. The camera system of claim 1, wherein the attachment means comprises a pair of claws for gripping the trigger guard.

4. The camera system of claim 1, wherein the attachment means comprises a bracket adapted to circumscribe a forward edge of the trigger guard.

5. The camera system of claim 1, wherein the attachment means comprises a bracket adapted to circumscribe a lower edge of the trigger guard.

6. The camera system of claim 1, wherein the camera is positioned beneath the motion-sensor to give the camera increased field of vision.

7. The camera system of claim 2, wherein the camera is positioned beneath the light-sensor to give the camera increased field of vision.

8. The camera system of claim 1, wherein the camera is positioned at a base of the trigger guard to give the camera increased field of vision.

9. The camera system of claim 1, further comprising a microphone.

10. A camera system detachably affixable to a firearm, the camera system comprising:
a cylindrical housing defining a hollow interior recess and an exterior recess contoured to receive a corner of a trigger guard of the firearm;
a bracket adapted to circumscribe a lower surface of the trigger guard and detachably affix the L-shaped housing to the lower surface of the trigger guard;
a digital camera having a lens, the lens of the digital camera oriented orthogonally to a barrel of the firearm such that the camera points toward anything positioned in front of the firearm;
a motion-sensor for activating the camera system disposed above the digital camera, the motion sensor positioned above the digital camera;
an internal power supply;
computer-readable memory for storing digital media; and
attachment means for detachably affixing the cylindrical housing to the corner of the trigger guard.

11. The camera system of claim 10, further comprising a light-sensor.

12. The camera system of claim 10, wherein the attachment means comprises a pair of claws for gripping the trigger guard.

13. The camera system of claim 10, wherein the attachment means comprises a bracket adapted to circumscribe a forward edge of the trigger guard.

14. The camera system of claim 10, wherein the attachment means comprises a bracket adapted to circumscribe a lower edge of the trigger guard.

15. The camera system of claim 10, wherein the camera is positioned at a base of the trigger guard to give the camera increased field of vision.

16. The camera system of claim 10, further comprising a microphone.

17. A camera system detachably affixable to a firearm, the camera system consisting of:
a cylindrical housing defining a hollow interior recess and an exterior recess contoured to receive a corner of a trigger guard of the firearm;
a bracket adapted to circumscribe a lower surface of the trigger guard and detachably affix the L-shaped housing to the forward surface of the trigger guard;
a digital camera having a lens, the lens of the digital camera oriented orthogonally to a barrel of the firearm such that the camera points toward anything positioned in front of the firearm;
a light-sensor for activating the camera system disposed above the digital camera, the light sensor positioned above the digital camera;
an internal power supply;
computer-readable memory for storing digital media; and
attachment means for detachably affixing the cylindrical housing to the corner of the trigger guard.

18. The camera system of claim 17, further comprising a microphone.

19. The camera system of claim 17, wherein the attachment means comprises a bracket adapted to circumscribe a forward edge of the trigger guard.

20. The camera system of claim 17, wherein the attachment means comprises a bracket adapted to circumscribe a lower edge of the trigger guard.
